(19) United States
(12) Patent Application Publication
(10) Pub. No.: US 2013/0047471 A1
(43) Pub. Date: Feb. 28, 2013

(54) ARTICLE OF FOOTWEAR

(71) Applicant: Changming LIANG, Shenzhen (CN)

(72) Inventor: Changming LIANG, Shenzhen (CN)

(21) Appl. No.: 13/238,165

(22) Filed: Sep. 21, 2011

(30) Foreign Application Priority Data
Aug. 29, 2011 (CN) 201110250502.6

(51) Int. Cl. A43B 3/00; A43B 23/02; B32B 3/26; A43D 86/00; A43B 23/07; A43B 23/24; A43C 5/00

(52) U.S. Cl. 36/136; 36/83; 12/146 C; 36/55; 428/156; 428/172

(57) ABSTRACT

The present disclosure provides an article of footwear including: a footwear upper formed of one or more pieces, each piece comprising one or more layers; and a footwear lower attached to the footwear upper to provide a sole supporting member to the article of footwear; wherein the one or more pieces used to form the footwear upper are molded into a three dimensional configuration. Also provided is a method for forming the same and an inner lining for an article of footwear.

### FIELD OF THE INVENTION

The present invention relates generally to footwear, and more particularly to the construction of an article of sports or casual footwear and a method for forming footwear in accordance with this construction.

### BACKGROUND TO THE INVENTION

Conventional sports and casual footwear is constructed from a number of pieces, each piece comprising various layers. The pieces forming the footwear upper for example, are stitched together and any external embellishments intended to increase the aesthetic appeal of the footwear are also stitched to the footwear upper. Whilst this method results in a sturdy construction, the presence of numerous seams within the article of footwear can lead to irritation and discomfort for the wearer. Moreover, the use of a number of pieces and various layers of different materials adds to the complexity and cost involved in constructing the article of footwear.

Accordingly, there is an ongoing effort by footwear manufacturers to develop footwear providing improved comfort at a reduced cost while enhancing aesthetic appeal.

### SUMMARY OF THE INVENTION

According to an aspect of the present invention, there is provided an article of footwear comprising:

a footwear upper formed of one or more pieces, each piece comprising one or more layers;

a footwear lower attached to the footwear upper to provide a sole supporting member to the article of footwear;

wherein the one or more pieces used to form the footwear upper are molded into a three dimensional configuration.

The molding preferably involves the application of heat and pressure.

According to an embodiment, at least one of the pieces forming the footwear upper may be multilayered. The multilayered piece may comprise an outer layer; a middle layer; and an inner layer.

Preferably, the footwear upper comprises a single layer.

In an alternate embodiment, the one or more pieces forming the footwear upper are joined so as to provide a substantially seamless inner surface.

Preferably, the footwear upper is formed from a single piece.

In one particular form, the footwear upper is formed from a single piece comprising an outer fabric layer, a middle foam layer and an inner fabric layer.

The footwear upper may include padding positioned at one or more anatomically determined positions to provide enhanced cushioning, reinforcement or support.

The footwear upper includes an upper opening to receive a wearer's foot, the upper opening having an upper edge, and a lower opening having a lower edge to which the footwear lower is attached to provide a sole supporting member. Preferably, the upper edge is finished to provide a seamless edge.

One or more decorative and/or structural features may be added to an outer surface of the footwear upper by use of a heat sealable film along at least an outer periphery of the decorative feature.

Structural features in the form of eyes for receiving shoe laces may be attached to the footwear upper using a heat sealable film.

According to another aspect of the present invention, there is provided a method for forming an article of footwear, the method comprising the following steps:

molding one or more pieces for forming a footwear upper into a suitable three dimensional configuration;

forming the footwear upper from the one or more pieces, each piece comprising one or more layers; and

attaching a footwear lower to the footwear upper to provide a sole supporting member to the article of footwear.

The molding preferably involves the application of heat and pressure.

The step of molding one or more pieces for forming a footwear upper into a suitable three dimensional configuration may include placing the piece into a heat press molding apparatus including complementary shaped first and second molding portions, wherein the first molding portion is configured to receive a complementary shaped second molding portion so that the piece is formed into a three dimensional configuration there between.

Preferably, the molding of each of the one or more pieces for forming a footwear upper into a suitable three dimensional configuration comprises the steps of:

providing a first sheet of material which is to be an outer layer of the footwear upper,

providing a second sheet of material which is to be an inner layer of the footwear upper,

providing between the first and second sheets of material a sheet of foam which is to be a middle layer of the footwear upper, and

molding together the first and second sheets of material and the sheet of foam to laminate the sheets.

Preferably, the first sheet of material and the second sheet of material each comprises a layer of fabric.

The footwear upper may be formed from more than one piece and each piece is joined to its adjacent piece by ultrasonic welding.

The footwear lower may be attached to the footwear upper by turning the upper inside out and joining a lower edge of the upper to the lower such that an external portion of the bottom supporting member will provide an outer sole when the article of footwear is turned right side out.

The footwear lower may be attached to the footwear upper by ultrasonic welding.

According to yet another aspect of the present invention, there is provided an inner lining for an article of footwear, comprising:

a footwear liner formed of one or more pieces, each piece comprising one or more layers, the footwear liner configured to receive a wearer's foot;

wherein the one or more pieces used to form the footwear liner are molded into a three dimensional configuration.

The inner lining may be placed within and fastened to a footwear upper to form an article of footwear.

According to one particular form of the invention, the inner lining is removably fastened to the footwear upper.

The footwear liner may be formed from one piece, the one piece being molded into a three dimensional configuration using a heat press molding apparatus.

The heat press molding apparatus may include complementary shaped first and second molding portions, wherein the first molding portion is configured to receive a complementary shaped second molding portion so that the footwear liner is formed into a three dimensional configuration there between.

Alternately, the footwear liner is formed from two pieces, each piece being molded into a three dimensional configuration using a heat press molding apparatus.

Preferably, one of the two pieces is independently molded into a left side piece and the other one of the two pieces is independently molded into a right side piece, such that the molded left side piece and the molded right side piece can be joined together to form the footwear liner configured to receive a wearer's foot.

The molded left side piece and the molded right side piece are joined together using non stitching means. Preferably, the molded left side piece and the molded right side piece are joined together by ultrasonic welding.

According to still another aspect of the present invention, there is provided an article of footwear including an inner lining, comprising:

a footwear upper;

a footwear liner formed of one or more pieces, each piece comprising one or more layers, the footwear liner configured to receive a wearer's foot; and

a footwear lower attached to the footwear upper to provide a sole supporting member to the article of footwear;

wherein the one or more pieces used to form the footwear liner are molded into a three dimensional configuration.

### BRIEF DESCRIPTION OF THE DRAWINGS

The invention will now be described in further detail by reference to the attached drawings illustrating example forms of the invention. It is to be understood that the particularity of the drawings does not supersede the generality of the preceding description of the invention. In the drawings:

FIG. 1 is a top view of a completed footwear article in accordance with an embodiment of the present invention.

FIG. 2 is a top view of a molded footwear upper in accordance with an embodiment of the present invention.

FIG. 3 is a top view of an example sole supporting member molded onto a canvas backing to form a footwear lower.

FIG. 4 is a top view of the molded footwear upper of FIG. 2 and the footwear lower of FIG. 3 showing how the footwear upper and footwear lower can be joined together.

FIG. 5 is a top view of a footwear article including a lower lining to be otherwise secured to a sole supporting member.

FIG. 6 is an example sole supporting member for use with the footwear article of FIG. 5.

FIGS. 7A, 7B, 7C, 7D and 7E show alternate means for finishing the upper edge of the footwear upper.

FIG. 8 is a top view of an alternate embodiment of a footwear upper in accordance with the present invention.

FIG. 9 is a top view of two pieces used to form the footwear upper of FIG. 8.

FIG. 10 is a top view of the footwear upper of FIG. 8 with decorative and structural features added to an outer surface of the footwear upper.

FIG. 11 is a top view of an alternate embodiment of the footwear upper of FIG. 8 with decorative and structural features added to an outer surface of the footwear upper.

FIGS. 12A and 12B are schematic diagrams showing how eyes for receiving shoe laces may be attached to the footwear upper.

FIGS. 13A and 13B are schematic diagrams showing how eyes for receiving shoe laces may be attached to the footwear upper according to an alternate embodiment.

FIG. 14 is a sectional view through a molding device consisting of an upper mold portion and a lower mold portion intermediate of which an assembly of precursor fabric and foam layers are placed for the simultaneous molding and lamination of the layers to form a molded piece, footwear upper, or inner lining having a three-dimensional configuration.

FIG. 15 is a top view of a completed footwear article in accordance with an embodiment of the present invention including an inner lining.

FIG. 16 is a cross section through line XVI of FIG. 15.

### DETAILED DESCRIPTION

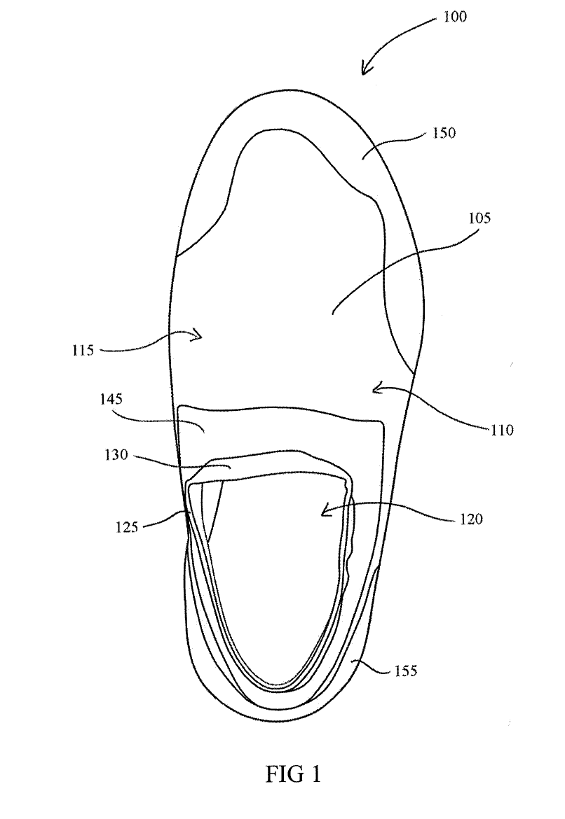

Referring firstly to FIG. 1, an article of footwear 100 comprises a footwear upper 105 and a footwear lower including a sole supporting member. Forming the footwear upper 105 involves molding one or more pieces 110 comprising the footwear upper into a three dimensional configuration. Each piece 110 forming the footwear upper 105 may comprise one or more layers.

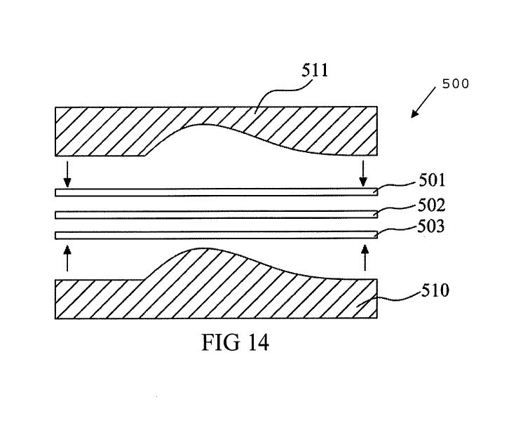

In the embodiment illustrated in FIG. 1, the footwear upper 105 comprises a single piece 110. This single piece 110 comprises three layers, an outer fabric layer 115, a middle foam layer (not shown) and an inner fabric layer (not shown). The three layers are molded using known heat molding techniques involving the application of heat and pressure to form a footwear upper 105 having a three dimensional configuration based substantially upon the shape of a human foot. As illustrated in FIG. 14, the molding process involves sandwiching precursor fabric layers 501, 503 and foam layer 502 which are to form the outer fabric layer 115, the middle foam layer and the inner fabric layer of the footwear upper 105 between the complementary mold portions 510, 511 of a molding machine which typically consists of a convex mold portion 510 and a complementary concave mold portion 511, each mold portion having surface relief features defining a molding surface of the resultant footwear upper 105.

The individual layers of the footwear upper 105 may be bonded or laminated during the molding process simply by the application of heat and pressure or may additionally involve the use of an adhesive to facilitate bonding of the layers. The appropriate bonding means will depend largely on the nature of the various layers, e.g. leather, fabric, foam, etc.

The perimeter of the molded precursor layers are subsequently trimmed to the desired shape of the footwear upper 105.

It will be appreciated that while the molding process as described above and illustrated in FIG. 14 involves the molding of three layers of material, the molding process is equally applicable where the footwear upper 105, or any of the pieces 110 comprising the footwear upper, comprises only one layer of material, in which case only one layer of material will be subject to the molding process as described.

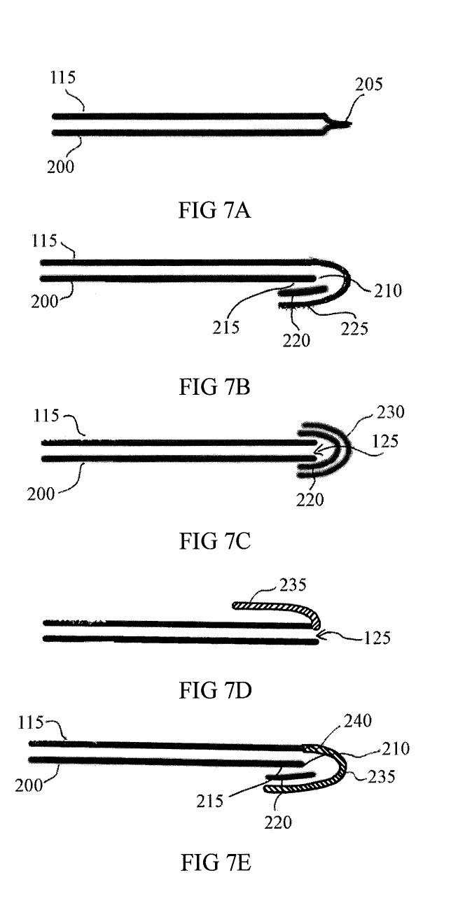

FIG. 1 shows a completed article of footwear 100 which will be broken down into its constituent components in the Figures to follow. Also shown in FIG. 1 is that the footwear upper 105 includes an upper opening 120 to receive a wearer's foot. The upper opening 120 has an upper edge 125. The upper edge 125 is finished using ultrasonic welding, or similar means, which simultaneously trims and welds the edge, to provide a neat and seamless finish. The upper edge 125 may be covered by an adhesive tape 130 or material with similar properties which is fold over the edge to protect the upper edge 125 and provide a neat appearance which is also comfortable to wear. The adhesive tape 130 or similar is preferably heat pressed to the upper edge 125 to ensure hard wearing finish. Further detail is shown in FIG. 7A.

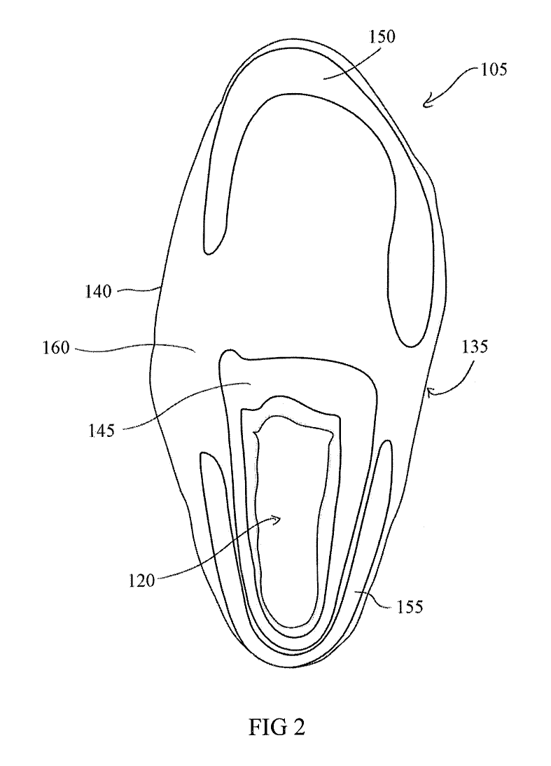

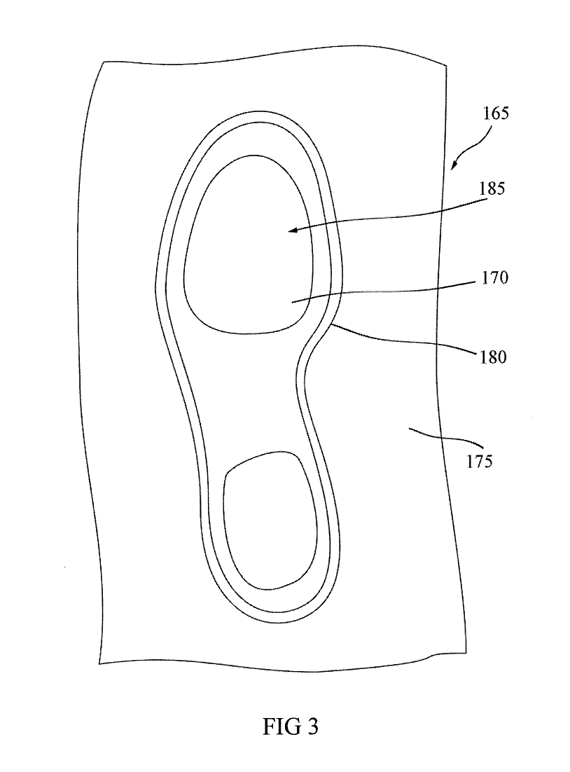

Referring now to FIG. 2, the footwear article of FIG. 1 comprises a one-piece molded footwear upper 105. The footwear upper 105 includes an upper opening 120 as described with reference to FIG. 1 and also a lower opening 135 having a lower edge 140 to which the footwear lower (not shown) is attached to provide the sole supporting member (see FIG. 3).

In FIGS. 1 and 2 the middle foam layer is supplemented by additional padding provided at anatomically determined positions. This padding may comprise for example a thicker region of foam 145 to provide enhanced cushioning around the upper opening 120 of the footwear upper 105. This provides enhanced comfort around the wearer's ankle. Additional foam padding or rubber inserts may be provided towards the periphery of the lower opening, i.e. immediately above where the footwear upper 105 will be joined to the footwear lower. Such inserts can be provided in the region of the footwear upper 105 corresponding to the toe 150 and heel regions 155 and also in the instep region 160. These inserts 150, 155, 160 provide additional support and reinforcement in those areas which are subject to additional wear due to their proximity to the extremities of a wearer's foot.

The footwear upper 105 may be formed from any material that is suitable for molding, for example by heat press molding, to shape the footwear upper into a three dimensional configuration adapted to receive a human foot. Suitable materials include fabric and/or leather for the outer and inner layers, and foam, thermoplastic rubber (TPR), thermoplastic polyurethane (TPU), silicone, ethylene vinyl acetate (EVA), polyvinyl chloride (PVC), polypropylene (PP), or the like for the middle layer and/or inserts.

It is to be understood that the article of footwear 100 could comprise a single layer of material, e.g. fabric or leather in which case there would be no middle layer comprising padding, inserts or otherwise and no inner fabric layer or lining.

FIG. 3 shows an example of a footwear lower 165. In this case a thermoplastic rubber (TPR) or thermoplastic polyurethane (TPU) sole support member 170 is attached to a fabric backing 175. Preferably the fabric backing 175 has waterproof and air permeable properties such as canvas or leather. The footwear lower 165 may be formed by injection molding, that is, the sole supporting member 170 is molded directly onto the fabric backing 175 during the injection molding process.

Referring to FIG. 4, the footwear lower 165 of FIG. 3 is joined to the molded footwear upper 105 of FIG. 2 by turning the footwear upper 105 inside out and joining a lower edge 140 of the upper to the periphery 180 of the sole supporting member 170 ensuring that the outer surface 185 of the sole supporting member 170 is facing the outer fabric layer 115 of the footwear upper. Once the footwear upper 105 is completely joined to the footwear lower 165, the article of footwear 100 is turned right side out so that the join is located inside the footwear article and the outer portion of the sole 185, i.e. the sole tread, is facing outwards. The join itself can be secured by means of stitching or ultrasonic welding. If the join is formed by ultrasonic welding, a heat pressed adhesive strip may be applied over the join to cover the welded edge.

In order for the article of footwear 100 to be suitable for assembly in the manner described in reference to FIG. 4, the materials forming the footwear upper 105 and footwear lower must be sufficiently flexible to allow the materials to be folded inside out and vice versa. In the case of a rigid sole support member 197, it will typically not be possible to turn the article of footwear 100 inside out which means an alternate method of manufacture is required.

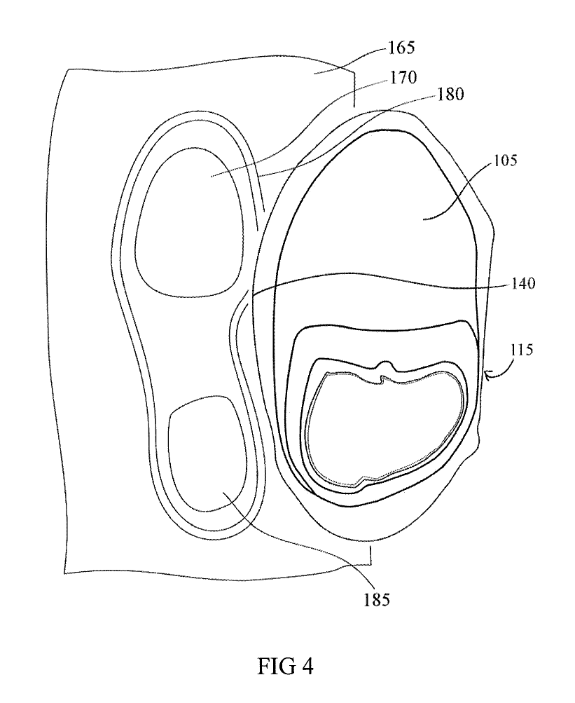

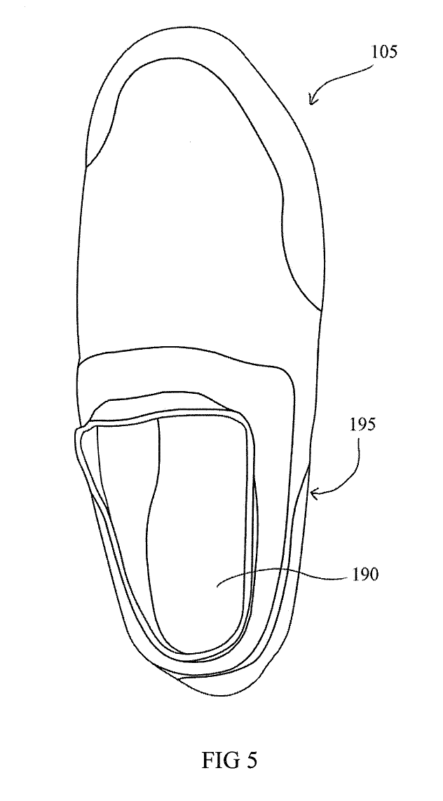

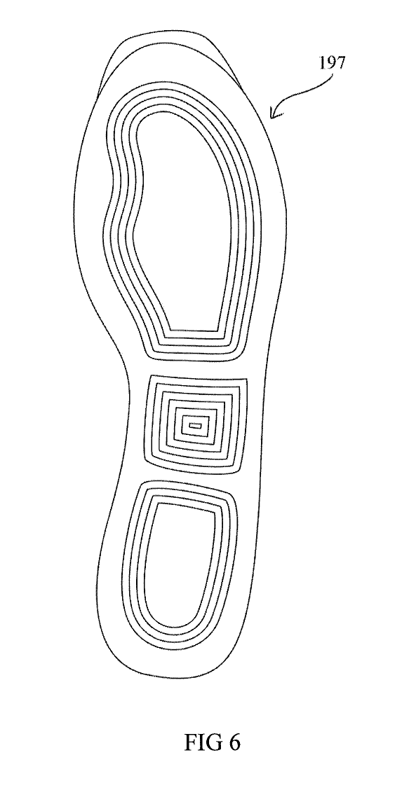

Referring now to FIGS. 5 and 6 an alternate method of manufacture is described. In the case of a rigid sole support member 197 a lower lining 190 comprising fabric or leather is joined to the footwear upper 105 in the manner described with reference to FIG. 4. The rigid sole support member 197 shown in FIG. 6 is then secured to the underside 195 of the lower lining 190 of the footwear upper 105 shown in FIG. 5. This method of manufacture avoids the need to turn the footwear upper 105 and the resulting article of footwear 100 inside out and vice versa.

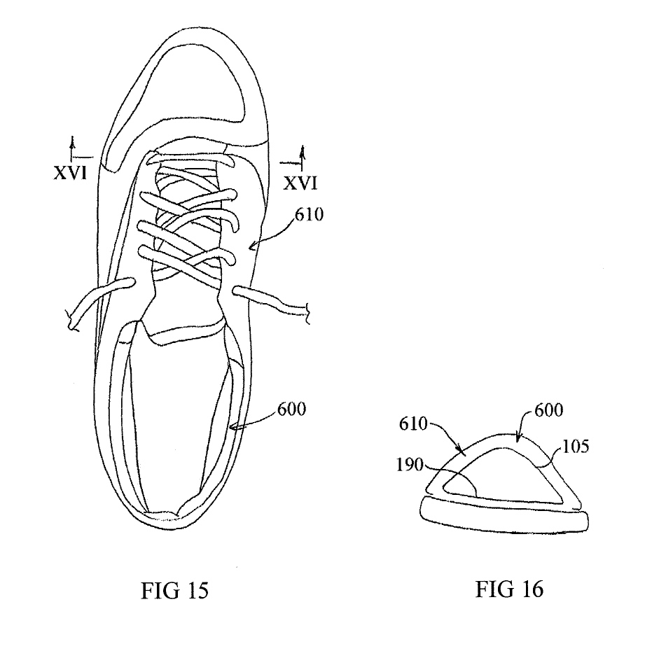

Referring now to FIGS. 15 and 16, according to an embodiment, the invention provides an inner lining for an article of footwear, the inner lining being substantially as shown in FIG. 5. In this case, the footwear upper 105 and lower lining 190 together form an inner lining 600 which may be placed within and fastened to a footwear upper to form an article of footwear. In other words, the footwear upper 105 becomes part of the inner lining 600 and does not form an upper of a footwear. The inner lining 600 may be permanently or removably fastened to the footwear upper 610. For example, the inner lining 600 may be stitched or ultrasonically welded to the footwear upper 610 to keep the inner lining in position during use of the article of footwear. Alternately it may be desirable to provide a removable inner lining 600 so that the inner lining itself can be replaced while continuing to use the same footwear upper 610. In this case, the means for fastening the inner lining 600 to the footwear upper 610 is releasable, for example by means of a hook and loop fastener.

FIGS. 7A, 7B, 7C, 7D and 7E show alternate means for finishing the upper edge 125 of the footwear upper 105. For simplicity, only an outer layer 115 and an inner layer 200 of the footwear upper 105 are shown. Referring firstly to FIG. 7A, there is shown a manner of finishing a seamless edge as described in reference to FIG. 1. That is, the upper edge 125 may be finished by ultrasonically trimming and welding the outer layer 115 and inner layer 200 together to form a welded edge 205.

Referring now to FIG. 7B, alternately, the upper edge 125 is finished by folding the outer layer 115 over a peripheral edge 210 of the inner layer 200 to cover the upper edge and a portion of the inner layer 215 which is proximal to the peripheral edge of the inner layer. Adhesive or a double sided adhesive tape 220 can be provided on the underside of the overlapping outer layer 225 to be secured by heat pressing.

Referring now to FIG. 7C, a folded strip 230 may be applied over the upper edge 125 to provide a contrasting colour or material for the edging. The folded strip 230 is applied at the edge 125 and may be secured thereto by placing a strip of double sided adhesive tape 220 between the inner layer 200/outer layer 115 and the folded strip. In the event that the folded strip 230 itself has an adhesive applied to the underside the double sided adhesive tape is not required. Heat pressing finishes the edge 125.

Referring now to FIGS. 7D and 7E there is shown another method for seamlessly finishing the upper edge 125. In this case, as shown in FIG. 7D, the outer layer 115 is extended by ultrasonically welding an additional piece of material or an extender 235 to the edge of the outer layer 240. As shown in FIG. 7E, the extender 235 is then folded over the peripheral edge of the inner layer 210 to cover the upper edge 125 and a portion of the inner layer 215 that is proximal to the peripheral edge of the inner layer similarly to the approach shown in FIG. 2. Adhesive or a double sided adhesive tape 220 can be provided on the underside of the extender 235 to be secured by heat pressing.

As described in reference to FIG. 1, the footwear upper 105 may be formed of one or more pieces, with each piece molded into a three dimensional configuration and then joining the molded pieces together, for example, by ultrasonic welding or other non-stitching means. The ultrasonic welding step is optionally followed by application of a heat pressed adhesive strip 130 to cover and protect the welded edge 205 and provide a seamless feel to the wearer. Each piece forming the footwear upper 105 may comprise one or more layers. The upper of the article of footwear 100 shown in FIGS. 1 to 5 is formed from a single piece of multilayered, molded fabric.

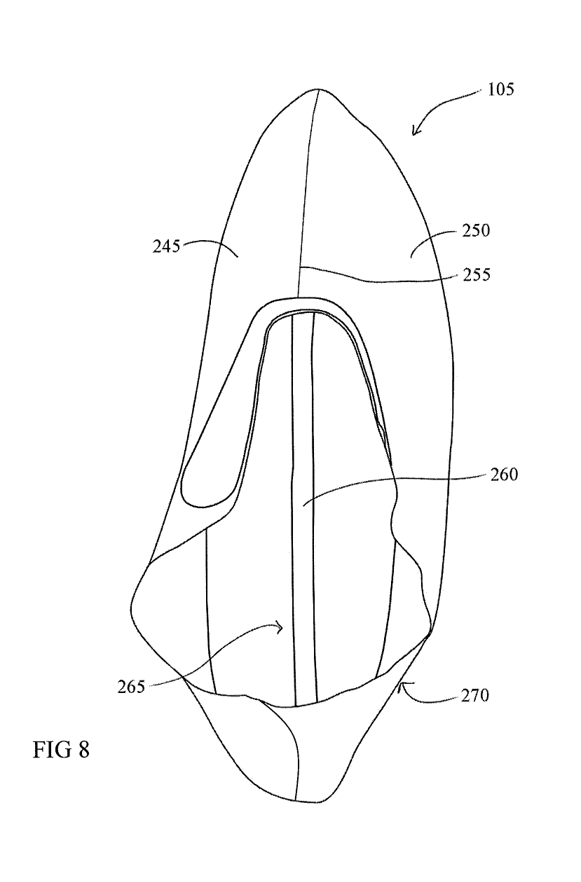

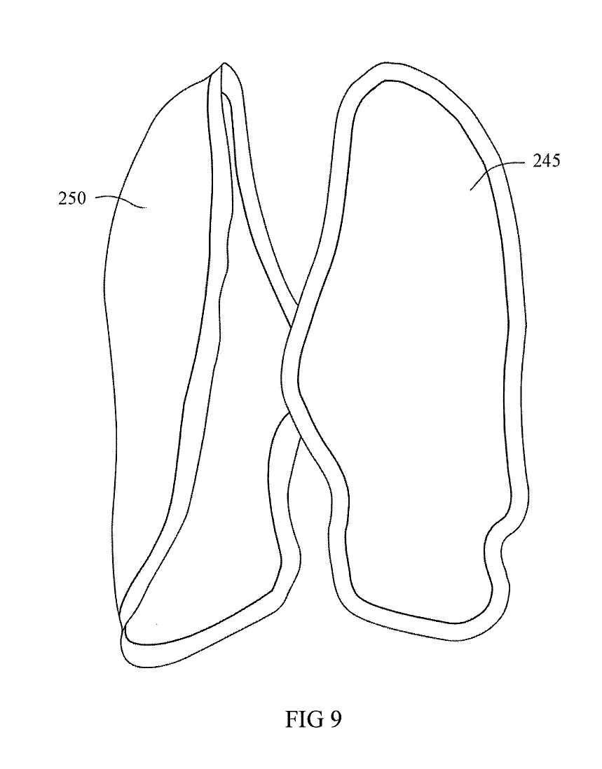

An example of an article of footwear 100 formed from more than one piece is shown in FIG. 8. In the illustrated embodiment, the footwear upper 105 is formed from two pieces of double layered fabric 245, 250. The pieces 245, 250 are separately subjected to heat press molding to achieve a suitable three dimensional configuration as seen in FIG. 9, before joining the pieces together by ultrasonic welding, stitching or other suitable means to form the footwear upper 105. If joined by ultrasonic welding, the pieces 245, 250 are simultaneously trimmed and welded to form a neat join 255 which may be covered by an adhesive strip 260. If the pieces 245, 250 are joined by stitching, any excess material will be removed to provide a neat join. Joining by non-stitching means is the preferred method of joining.

In the embodiment shown in FIG. 8, the two pieces 245, 250 are cut and molded such that when they are joined the footwear upper 105 forms not only the visible portion of the article of footwear 100, but also a lower lining 265 which will be joined with the sole support member 197 (see FIG. 6). Accordingly, the steps for completing the article of footwear 100 are similar to that described in reference to FIGS. 5 and 6, where the sole support member 197 is secured to the underside 270 of the lower lining 265 to avoid the need to turn the footwear upper 105 and the resulting article of footwear 100 inside out and vice versa. This allows a more rigid sole support member to be used.

According to an embodiment of the invention, the two pieces 245, 250 form an inner lining for an article of footwear. That is, the two pieces are joined together to form a footwear liner configured to receive a wearer's foot which is placed within and fastened to a footwear upper to form an article of footwear. In other words, the pieces 245, 250 become the inner lining and do not form an upper of a footwear. The inner lining is either permanently or removably fastened to the footwear upper, as described with reference to FIGS. 15 and 16, i.e., the inner lining is stitched or ultrasonically welded to the footwear upper or alternately is releasably secured to the footwear upper using for example, hook and loop fastening means.

The two pieces 245, 250 are individually molded into a suitable three-dimensional form configured for receiving a wearer's foot before the two pieces are joined together to form the inner lining. The pieces are independently molded using a heat press molding apparatus which employs first and second complementary shaped molding portions, wherein the first molding portion is configured to receive a complementary shaped second molding portion so that the inner lining is heat press molded there between.

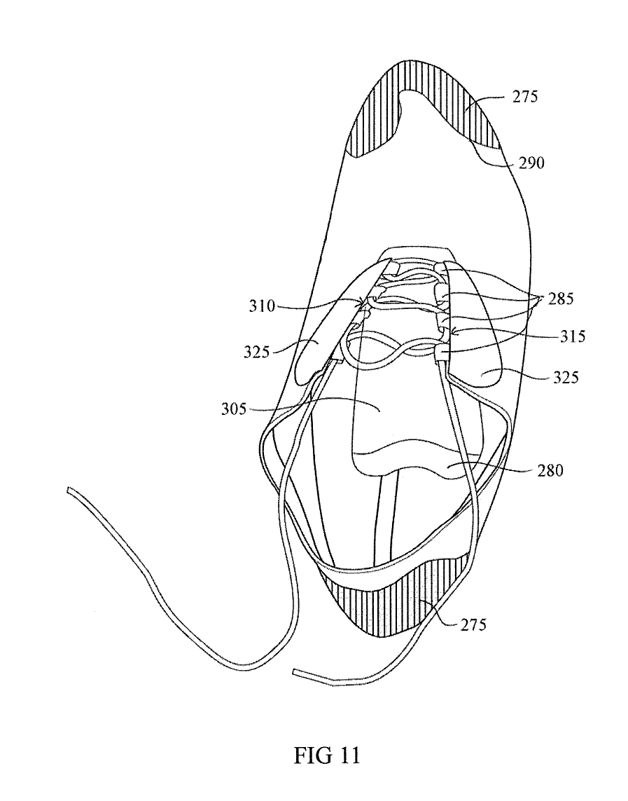

With reference to FIG. 8, before completing the article of footwear 100 as described in reference to FIG. 8 by addition of the sole support member 197, decorative and/or structural features may be added to an outer surface of the footwear upper 105. For example, fabric or leather 275 in a contrasting colour or texture may be applied over certain parts of the footwear upper 105 to provide aesthetic appeal. Contrasting trim can be applied to the edge of the upper opening as described in reference to FIG. 2. Moreover, structural elements like a tongue 280 and eyes 285 (see FIG. 11) for receiving shoe laces or other closure means may be added to the footwear upper 105 to provide both aesthetic appeal and functional enhancement.

Such decorative and/or structural features are added to the footwear upper 105 using heat sealable film, such as for example thermoplastic polyurethane (TPU) film. For example if applying a contrasting fabric or leather 275 over a certain portion of the footwear upper 105, the heat sealable film may be used for joining purposes either along at least an outer periphery 290 of the decorative feature 275 or between the entire piece of decorative fabric or leather and the footwear upper by applying heat thereto.

Structural features such as the tongue 280 or fastening means such as eyes 285 for shoe laces are attached to the footwear upper 105 in a similar manner. Where a tongue 280 and/or shoe laces or other closure means such as for example a hook and loop style fastener are to be added to the footwear upper 105, the upper opening 120 is extended towards the toe region 300 of the footwear upper. This extension 295 of the upper opening 120 will typically extend to at least midway between the extremity of the toe region 300 and the end of the original upper opening 120 which is most proximal thereto.

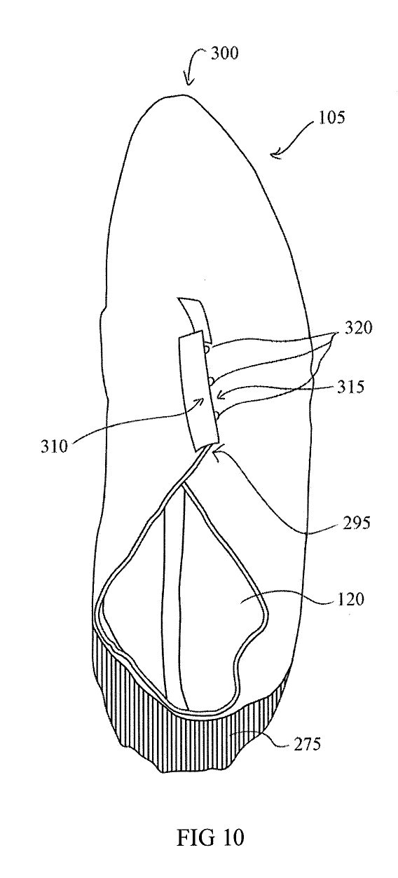

If a tongue 280 is to be added to the footwear upper 105 as shown in FIG. 11, the tongue itself may optionally be decorated by applying decorative feature such as a fabric or leather 305 in a contrasting colour or texture over the tongue or a part thereof using a heat sealable film as described. The tongue 280 is attached to the end of the extension 295 to the upper opening 120 which is distal to the original upper opening and proximal to the toe region 300. The tongue 280 is secured to the footwear upper 105 using a heat sealable film to hold the tongue in place.

Where shoelaces are to be used as closure means, eyes 285 for receiving the shoe laces may be provided on opposing edges 310, 315 of the extension 295 to the upper opening 120. Referring now to FIG. 10, there is shown a first example of eyes on the footwear upper 105. In this case the eyes 320 are formed of metal and shaped so as to receive a shoe lace through one end and to maximise the surface area of the metal eye 320 in contact with the footwear upper 105 at the other. The metal eyes 320 are secured to opposing edges 310, 315 of the extension 295 to the upper opening 120 using a heat sealable film.

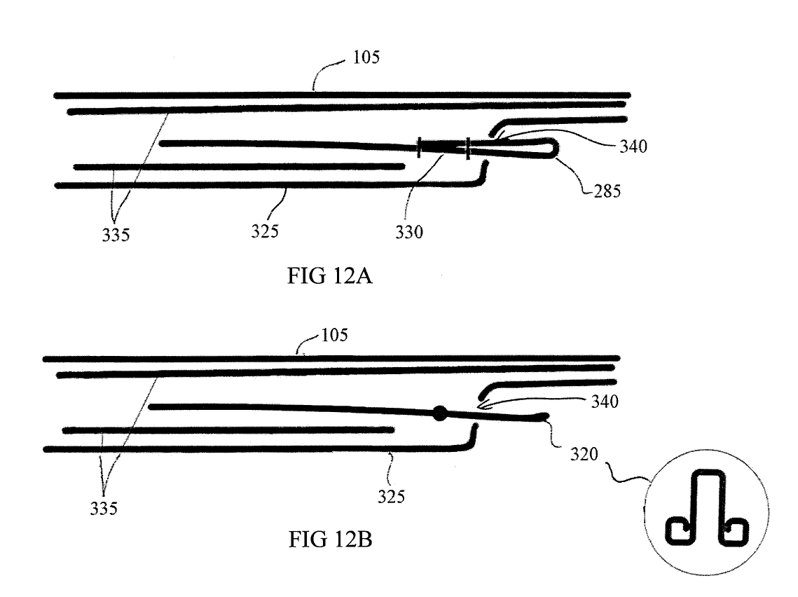

In the alterative shown in FIG. 11, shoe lace loops 285 are formed from fabric to receive a shoe lace through the closed end of the loop, whilst the open end of the loop is secured to the footwear upper 105. Referring to FIG. 12A, a heat sealable adhesive film is used to effectively sandwich the shoe lace loops 285 between the footwear upper 105 and a piece of additional fabric or leather 325 which may be provided in a different colour and/or texture to provide a feature of interest. The shoe lace loop 285 in the illustrated embodiment comprises a flat strip folded in two to provide a closed loop at one end 285, with an open end 330 placed between two strips of heat sealable adhesive film 335, the first effectively securing the shoe lace loop 285 directly to the footwear upper 105 and the second securing a piece of fabric or leather 325 over the lace loop 285 and footwear upper 105 to ensure a strong and aesthetically pleasing fixture. A small opening 340 is cut into the piece of fabric or leather 325 through which the shoe lace loop 285 is passed to provide access to the closed loop.

Referring now to FIG. 12B, the heat sealable adhesive film is used to secure the metal eye 320. The metal eye 320 is placed between two strips of heat sealable adhesive film 335, the first effectively secures the metal eye 320 directly to the footwear upper 105 and the second secures a piece of fabric or leather 325 over the metal eye 320 and footwear upper 105 to ensure a strong fixture and optionally provide contrast in colour and/or texture to further add aesthetic appeal. A small opening 340 is cut into the piece of fabric or leather 325 through which the metal eye 320 protrudes to allow access to the eye.

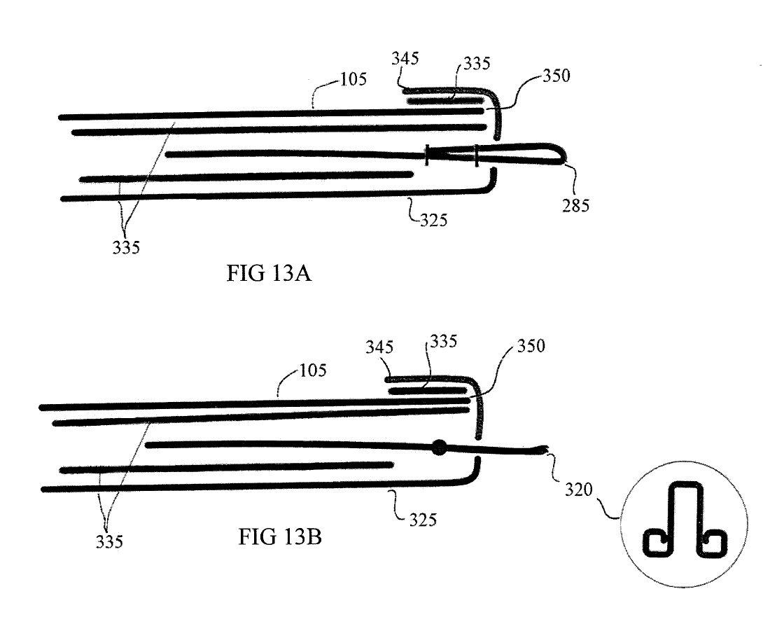

Referring now to FIG. 13A, there is shown an alternative means of securing the shoe lace loop 285 to the footwear upper 105 which further involves folding the edge 345 of the piece of fabric or leather 325 through which the shoe lace loop passes over the edge 350 of the footwear upper such that the shoe lace loop protrudes beyond the edge of the footwear upper causing the closed loop to be exposed.

Referring now to FIG. 13B there is shown an alternative means of securing the metal eye 320 to the footwear upper 105 which further involves folding the edge 345 of the piece of fabric or leather 325 through which the metal eye passes over the edge of the footwear upper such that the metal eye protrudes beyond the edge of the footwear upper causing the eye to be exposed.

Also provided by the present invention is a method for forming an article of footwear. As will be apparent from the preceding description, the method comprises forming a footwear upper from one or more pieces, each piece comprising one or more layers. The pieces intended to form the footwear upper are molded, for example by heat press molding, into a suitable three dimensional configuration adapted to receive a wearer's foot. The single piece footwear upper or multi piece footwear upper (in which case the pieces are first joined) are then attached to a footwear lower to provide a sole supporting member to the article of footwear.

Referring now to FIG. 14, whether formed from one or more pieces, the footwear upper 105 or, in some embodiments, the footwear liner is molded, either as a one piece structure or as two or more independently molded pieces which are subsequently joined together to form the footwear upper or, in some embodiments, the footwear liner, using a heat press molding process and apparatus. The heat press apparatus 500 includes first and second complementary shaped molding portions 510, 511 wherein a first molding portion 511 is configured to receive a complementary shaped second molding portion 510 so that the footwear upper 105 or, in some embodiments, the footwear liner is heat press molded there between. In the illustrated embodiment, the footwear upper, which may form a footwear liner in some embodiments, consists of three layers, and the precursor layers 501, 502, 503 which are to form the outer layer, the middle foam layer and the inner layer are subject to heat press molding between the complementary shaped molding portions. However in accordance with the preceding description, it is to be understood that the footwear upper or liner may comprise a singe layer as shown in FIG. 8 for example.

The heat press molding process involves placing the precursor piece comprising one or more layers (to form the footwear upper or footwear liner) in a heat press apparatus including first and second complementary shaped molding portions. The heat press apparatus may be a hydraulic press with the first molding portion configured to receive a complementary shaped second molding portion, i.e. such that the first molding portion 511 is substantially inwardly curving or concave. The second molding portion 510 is substantially outwardly curving or convex and shaped so as to be received within the concavity of the first molding portion. The precursor piece is placed on the second molding portion and the first molding portion is lowered onto the second molding portion, compressing the precursor piece there between (or vice versa). The application of heat and compression, causes the precursor piece to be formed into a three dimensional configuration.

Where the footwear upper 105 is formed from more than one piece, the individual pieces are preferably each joined to their adjacent piece by ultrasonic welding. The weld may further be covered by a strip of heat sealable film.

In one particular embodiment, the footwear lower is attached to the molded footwear upper by turning the footwear upper inside out and joining a lower edge of the footwear upper to the footwear lower such that an external portion of the bottom supporting member will provide an outer sole when the completed article of footwear is turned right side out. This particular means of attaching the footwear upper to the footwear lower will be suitable only in the case where the materials forming the footwear upper and lower are sufficiently flexible to permit the entire article of footwear to be turned inside out and vice versa.

The article of footwear which is the subject of the present invention provides versatile article of footwear which is simple to manufacture and both lightweight and comfortable to wear. In one embodiment, wherein the footwear upper is formed form a single piece, the article of footwear is seam free avoiding joins which may cause irritation to a wearer. In the alternate embodiment, wherein two or more pieces are joined together to form the footwear upper, the joins are preferably simultaneously trimmed and ultrasonically welded resulting in a very neat join having no raised regions likely to irritate a wearer.

While the invention has been described in conjunction with a limited number of embodiments, it will be appreciated by those skilled in the art that many alternative, modifications and variations in light of the foregoing description are possible. Accordingly, the present invention is intended to embrace all such alternative, modifications and variations as may fall within the spirit and scope of the invention as disclosed.

1. An article of footwear comprising:
a footwear upper formed of one or more pieces, each piece comprising one or more layers;
a footwear lower attached to the footwear upper to provide a sole supporting member to the article of footwear;
wherein the one or more pieces used to form the footwear upper are molded into a three dimensional configuration.

2. An article of footwear according to claim 1, wherein at least one of the pieces forming the footwear upper is multilayered.

3. An article of footwear according to claim 2, wherein the multilayered piece comprises:
an outer layer;
a middle layer; and
an inner layer.

4. An article of footwear according to claim 1, wherein the footwear upper comprises a single layer.

5. An article of footwear according to claim 1, wherein the one or more pieces forming the footwear upper are joined so as to provide a substantially seamless inner surface.

6. An article of footwear according to claim 1, wherein the footwear upper is formed from a single piece.

7. An article of footwear according to claim 6, wherein the footwear upper is formed from a single piece comprising an outer fabric layer, a middle foam layer and an inner fabric layer.

8. An article of footwear according to claim 2, wherein the footwear upper includes padding positioned at one or more anatomically determined positions to provide enhanced cushioning, reinforcement or support.

9. An article of footwear according to claim 1, wherein the footwear upper includes an upper opening to receive a wearer's foot, the upper opening having an upper edge, and a lower opening having a lower edge to which the footwear lower is attached to provide a sole supporting member, wherein the upper edge is finished to provide a seamless edge.

10. An article of footwear according to claim 1, wherein one or more decorative and/or structural features are added to an outer surface of the footwear upper by use of a heat sealable film along at least an outer periphery of the decorative feature.

11. An article of footwear according to claim 10, wherein structural features in the form of eyes for receiving shoe laces are attached to the footwear upper using a heat sealable film.

12. An article of footwear according to claim 1, wherein the molding involves the application of heat and pressure.

13. A method for forming an article of footwear, the method comprising the following steps:
molding one or more pieces for forming a footwear upper into a suitable three dimensional configuration;
forming the footwear upper from the one or more pieces, each piece comprising one or more layers; and
attaching a footwear lower to the footwear upper to provide a sole supporting member to the article of footwear.

14. A method for forming an article of footwear according to claim 13, wherein the step of molding one or more pieces for forming a footwear upper into a suitable three dimensional configuration includes placing the piece into a heat press molding apparatus including complementary shaped first and second molding portions, wherein the first molding portion is configured to receive a complementary shaped second molding portion so that the piece is formed into a three dimensional configuration there between.

15. A method for forming an article of footwear according to claim 13, wherein the footwear upper is formed from more than one piece and each piece is joined to its adjacent piece by ultrasonic welding.

16. A method for forming an article of footwear according to claim 13, wherein the footwear lower is attached to the footwear upper by turning the upper inside out and joining a lower edge of the upper to the lower such that an external portion of the bottom supporting member will provide an outer sole when the article of footwear is turned right side out.

17. A method for forming an article of footwear according to claim 13, wherein the footwear lower is attached to the footwear upper by ultrasonic welding.

18. A method for forming an article of footwear according to claim 13, wherein the molding involves the application of heat and pressure.

19. A method for forming an article of footwear according to claim 13, wherein the molding of each of the one or more pieces for forming a footwear upper into a suitable three dimensional configuration comprises the steps of:
providing a first sheet of material which is to be an outer layer of the footwear upper,
providing a second sheet of material which is to be an inner layer of the footwear upper,
providing between the first and second sheets of material a sheet of foam which is to be a middle layer of the footwear upper, and
molding together the first and second sheets of material and the sheet of foam to laminate the sheets.

20. A method for forming an article of footwear according to claim 19, wherein the first and second sheets of material each comprises a layer of fabric.

21. An inner lining for an article of footwear, comprising:
a footwear liner formed of one or more pieces, each piece comprising one or more layers, the footwear liner configured to receive a wearer's foot;
wherein the one or more pieces used to form the footwear liner are molded into a three dimensional configuration.

22. An inner lining for an article of footwear according to claim 21, wherein the inner lining is placed within and fastened to a footwear upper to form an article of footwear.

23. An inner lining for an article of footwear according to claim 22, wherein the inner lining is removably fastened to the footwear upper.

24. An inner lining for an article of footwear according to claim 21, wherein the footwear liner is formed from one piece, the one piece being molded into a three dimensional configuration using a heat press molding apparatus.

25. An inner lining for an article of footwear according to claim 24, wherein the heat press molding apparatus includes complementary shaped first and second molding portions, wherein the first molding portion is configured to receive a complementary shaped second molding portion so that the footwear liner is formed into a three dimensional configuration there between.

26. An inner lining for an article of footwear according to claim 21, wherein the footwear liner is formed from two pieces, each piece being molded into a three dimensional configuration using a heat press molding apparatus.

27. An inner lining for an article of footwear according to claim 26, wherein one of the two pieces is independently molded into a left side piece and the other one of the two pieces is independently molded into a right side piece, such that the molded left side piece and the molded right side piece can be joined together to form the footwear liner configured to receive a wearer's foot.

28. An inner lining for an article of footwear according to claim 27, wherein the molded left side piece and the molded right side piece are joined together using non stitching means.

29. An inner lining for an article of footwear according to claim 27, wherein the molded left side piece and the molded right side piece are joined together by ultrasonic welding.

30. An article of footwear including an inner lining, comprising:
a footwear upper;
a footwear liner formed of one or more pieces, each piece comprising one or more layers, the footwear liner configured to receive a wearer's foot; and
a footwear lower attached to the footwear upper to provide a sole supporting member to the article of footwear;
wherein the one or more pieces used to form the footwear liner are molded into a three dimensional configuration.
